(19) United States
(12) Patent Application Publication
(10) Pub. No.: US 2006/0188631 A1
(43) Pub. Date: Aug. 24, 2006

(54) Pregelatinized chemically modified resistant starch products and uses thereof

(76) Inventors: Kyungsoo Woo, Shawnee, KS (US); Sukh D. Bassi, Atchison, KS (US); Clodualdo C. Maningat, Platte City, MO (US); Lianfu Zhao, Atchison, KS (US); Edward E. Trompeter, Atchison, KS (US); George A. Kelley JR., Atchison, KS (US); Shishir Ranjan, Atchison, KS (US); Jennifer Gaul, Effingham, KS (US); Christopher T. Dohl, Netawaka, KS (US); Glenn K. DeMeritt JR., Atchison, KS (US); Gregory J. Stempien, Atchison, KS (US); Kevin D. Krehbiel, Atchison, KS (US)

Correspondence Address: LATHROP & GAGE LC, 4845 PEARL EAST CIRCLE, SUITE 300, BOULDER, CO, 80301, US

(21) Appl. No.: 11/294,314

(22) Filed: Dec. 5, 2005

Related U.S. Application Data
(63) Continuation-in-part of application No. 11/283,934, filed on Nov. 21, 2005.
(60) Provisional application No. 60/654,100, filed on Feb. 18, 2005.

(51) Int. Cl. A21D 10/00

(52) U.S. Cl. 426/549

(57) ABSTRACT

Pregelatinized forms of chemically modified resistant starches are provided which have a high degree of resistance to α-amylase digestion, fat-like texture and outstanding freeze-thaw stability. The starch products are formed as distarch phosphodiesters that undergo melting of the crystalline phase by heating above their gelatinization temperature. The products maintain a granular morphology that produces a smooth texture. The pregelatinized resistant starches may be used in various food products, where they lend high dietary fiber, low fat and/or low calorie characteristics to the product.

### RELATED APPLICATIONS

This application is a continuation-in-part of copending application Ser. No. 11/283,934 titled “Pregelatinized Chemically Modified Resistant Starch Products”, filed Nov. 21, 2005, which claims the benefit of priority to U.S. provisional patent application Ser. No. 60/654,100, filed Feb. 18, 2005, each of which is incorporated herein by reference.

### FIELD OF THE INVENTION

The present invention is concerned with pregelatinized forms of chemically modified resistant starches, food products containing such starches, and methods of preparing the same. The resistant starch products show low caloric density, high dietary fiber content, and fat-like texture, as well as excellent stability during repeated cycles of freezing and thawing.

### BACKGROUND

Starch serves as a food reserve in plants, and is an important component in the human diet, where the digestion of starch is mediated by salivary and pancreatic α-amylase. The α-amylase enzyme catalyzes formation of maltose, maltotriose, and dextrin, which are further hydrolyzed to d-glucose in the brush-border of the small intestine. However, some starch resists digestion by α-amylase. Englyst et al. (1992, Eur. J. Clin Nutr) classified ingested starch based on its probable digestive fate in vivo. They proposed three classes of dietary starch: 1) rapidly digestible starch (RDS), which is likely to be digested in the human intestine; 2) slowly digestible starch (SDS), which is likely to be slowly yet completely digested in the small intestine; and 3) resistant starch (RS), which is unlikely to be digested in the small intestine.

RS has been subdivided into four categories depending on the cause of resistance (Englyst et al. 1992, Eerlingen et al. 1993): RS1, physically inaccessible starch due to entrapment in a nondigestible matrix; RS2, raw starch granules with crystallinity; RS3, retrograded amylose; and RS4, chemically modified starch.

Together with SDS, RS has been linked to foods with reduced glycemic indexes which do not provoke an intense insulin response and are thought to be beneficial for all individuals, especially those with type II diabetes.

RS is also recognized as one component of dietary fiber, where it has been shown to be a mild laxative. RS is partially fermented in the colon to short chain fatty acids which reduce fecal pH and consequently inhibit the activity of 7-dehydroxylase, which forms secondary bile acids associated with an increased risk of colon cancer. Short chain fatty acids, such as acetic, propionic, and butyric, are also shown to stimulate colonic blood flow and electrolyte absorption.

### SUMMARY

In one aspect, a pregelatinized resistant starch includes a plurality of individual, cross-linked starch granules, where the granules lack a crystalline phase. Lack of a crystalline phase may be shown, for example, by a differential scanning calorimetry graph of the pregelatinized starch that does not show an endothermic gelatinization transition. Lack of a crystalline phase may also, or alternatively, be observed as a lack of birefringence when the pregelatinized starch is viewed in plane polarized light under a microscope.

In one aspect, food products may be made from the pregelatinized resistant starch. The pregelatinized resistant starch may be stable during successive freezing and thawing cycles without the loss of more than about 20-25% water content.

In one aspect, the pregelatinized resistant starch may be prepared by a method including forming a dispersion of starch granules in water, the granules undergoing swelling in the dispersion and having a crystalline phase. A cross-linking agent is added to the dispersion while the granules are swelled, and the dispersion of cross-linked starch is then heated in order to completely melt the crystalline phase of the granules, without disrupting the granular morphology.

### BRIEF DESCRIPTION OF THE DRAWINGS

FIG. 1 shows a light micrograph of pregelatinized cross-linked wheat starch.

FIG. 2 shows a scanning electron micrograph (SEM) of pregelatinized cross-linked resistant starch.

FIG. 3 shows water loss during ten cycles of freezing and thawing.

FIG. 4 shows a SEM of pregelatinized cross-linked resistant starch after 10 cycles of freezing and thawing.

FIG. 5 shows a differential scanning calorimetry graph where disappearance of a gelatinization endotherm is observed for pregelatinized cross-linked starch.

FIG. 6 shows polarized light micrographs where birefringence that is observed in native starch (A) has disappeared in pregelatinized cross-linked starch (B).

### DETAILED DESCRIPTION

As used herein, the term “pregelatinized” shall refer to non-crystalline starch that retains individual granular structure.

As used herein, “complete melting of the crystalline phase” or “complete gelatinization” shall refer to loss of birefringence of the starch granules when viewed by a microscope under plane polarized light and/or to the absence of a gelatinization endotherm when the starch product is tested by differential scanning calorimetry.

Pregelatinized forms of chemically modified resistant starches are provided which have low caloric density, high dietary fiber content, excellent freeze-thaw stability, and fat-like texture. The products are prepared by cross-linking starch, followed by melting of the crystalline phase of the granular structure. Loss of crystallinity is characterized by disappearance of birefringence in granules viewed by a plane polarized light microscope, and/or by disappearance of a gelatinization endothermic peak in a differential scanning calorimetry (DSC) graph.

The pregelatinized chemically modified resistant starch products exhibit at least about 20% resistance to α-amylase digestion, more preferably at least about 35% resistance, and most preferably at least about 50% resistance to α-amylase digestion as measured by Association of Official Analytical Chemists 2002 (AOAC) Method 991.43. Further, the products present a smooth granular structure with fat-like texture in water, exhibit limited water loss during repeated freezing and thawing cycles, and disperse readily in cold and hot water. The products may be advantageously used in reduced fat, low calorie and high fiber food products, especially in frozen food applications. For example, frozen food products may be selected from the group consisting of cereal grain, frozen desserts, yogurt, and ice cream.

Virtually any unmodified starch can be modified according to the methods described herein, including starches selected from the group consisting of cereal, root, tuber and legume. Further starches include those selected from wheat, waxy wheat, corn, waxy corn, high amylose corn, oat, rice, tapioca, mung bean, sago, sweet potato, potato, barley, triticale, sorghum, banana and other botanical sources including waxy, partial waxy, and high amylose variants (“waxy” being intended to include at least about 95% by weight amylopectin, and “high amylose” being intended to include at least about 40% by weight amylose). Chemically, physically or genetically modified forms of starches can also be used. Modification techniques include 1) treatment with chemicals and/or enzymes according to 21 CFR 172.892; 2) physical transformations such as retrogradation (recrystallization), heat treatment, partial gelatinization, annealing and roasting; 3) genetic modifications including gene or chromosome engineering, such as cross-breeding, translocation, inversion and transformation; and 4) combinations of the above.

Pregelatinized chemically modified resistant starches are made by a process involving first forming a dispersion of starch granules in water where the starch granules have an intact crystalline phase. The dispersion typically contains greater than about 15% by weight starch, and more typically greater than about 30% by weight thereof. A cross-linking agent is added to the dispersion under conditions that avoid gelatinization. After cross-linking, the starch granules are heated in excess water to completely melt the crystalline phase of the granules. Suitable cross-linking conditions and parameters are set forth in U.S. Pat. No. 5,855,946, which is expressly incorporated by reference herein.

Starches can be chemically cross-linked using a variety of cross-linking agents. However, the Food and Drug Administration regulates compositions and concentrations of chemicals used in food production. See 21 CFR §172.892(d), which limits either the reagent concentration during production or the phosphorus content of the finished product, as follows:
Phosphorus oxychloride (not to exceed 0.1% in reaction mix)
Sodium trimetaphosphate (residual phosphate not to exceed 0.04%, calculated as phosphorus)
Sodium trimetaphosphate and sodium tripolyphosphate (residual phosphate not to exceed 0.4%, calculated as phosphorus).
   Thus, preferred cross-linking agents are those selected from the group consisting of sodium trimetaphosphate (STMP), sodium tripolyphosphate (STPP), phosphoryl chloride, and mixtures thereof. One skilled in the art would appreciate that other cross-linking agents may be used with similar effect, and may be unregulated outside of the United States. For example, adipic acid and epichlorohydrin may be used.

Generally, where a mixture of STMP and STPP is used it should comprise from about 1-20% by weight STMP, preferably from about 5-12% by weight STMP, and from about 0.01-0.2% by weight STPP, preferably 0.05-0.12% by weight STPP. The STMP/STPP mixture is advantageously used at a level of from about 1-20% by weight, and preferably from about 5-12% by weight. Where STMP is used alone, it may be used at a level of from about 1-20% by weight, and preferably from about 5-12% by weight. Unless otherwise specified, percentages are based on the weight of the starting unmodified starch taken as 100% by weight. Cross-linked starches as described herein have been phosphorylated to form distarch phosphate diesters. The cross-linked starches contain at least about 0.1% by weight phosphorus, and preferably about 0.2% by weight thereof. For example, cross-linked starches may contain phosphorus in a range of about 0.1-0.4% by weight thereof.

Cross-linking reactions are carried out at basic pH from about 10-13, preferably from about 11-12. Alkalinity improves the yield of distarch phosphate (i.e., cross-linked starch) as a predominant form of modified starch. The competitive substitution reaction which leads to monostarch monophosphate formation is minimized. The reaction is carried out at about 25-70° C., and preferably at about 30-50° C. A sufficient reaction time is from about 10 minutes to about 24 hours, preferably from about 1-12 hours.

In certain cases, it is possible to perform cross-linking reactions above normal gelatinization temperatures using a combination of salt addition and a controlled rate of temperature increase. For example, where STMP or an STMP/STPP mixture is used as the cross-linking agent, salt is added to the starch dispersion in an amount from about 0.1-20% by weight, based upon the weight of the starting starch taken as 100% by weight, in the form of sodium sulfate or sodium chloride. Added salt retards gel formation during the cross-linking reaction and increases alkali (base) absorption into the starch granules. Increased alkali inside the granules makes starch more reactive to chemical reagents such as STMP and STPP, and provides more favorable reaction conditions for distarch phosphate formation. Upon completion of the cross-linking reaction, the dispersion is neutralized with hydrochloric acid solution and the starch is washed with water to remove unreacted salt.

In the gelatinization step, the cross-linked starch granules are heated in excess water to melt the crystalline phase of the granules. In the initial stage of heating, reversible hydration and swelling occur rapidly in the amorphous phase of the starch granules. Starch molecules are become more loosely associated after the crystalline phase of the starch is melted, which requires disrupting hydrogen bonding in the crystalline network. The present instrumentalities involve heating cross-linked resistant starch in excess water at a temperature sufficient to achieve complete gelatinization of granular starch. For example, an aqueous dispersion (10-30% w/w) of cross-linked resistant starch is heated above the gelatinization temperature with stirring for about 30 minutes. The cooked product is then cooled, centrifuged, and dried in a conventional oven, hydrothermal heater, jet cooker, spray cooker, extruder, drum dryer, and/or spray drier. The preferred temperature of heating is above 80° C. in the case of non-high amylose starch. In the case of high amylose starch, the temperature may be above 110° C. The resulting products are dried to below about 20%, preferably below about 15%, moisture content.

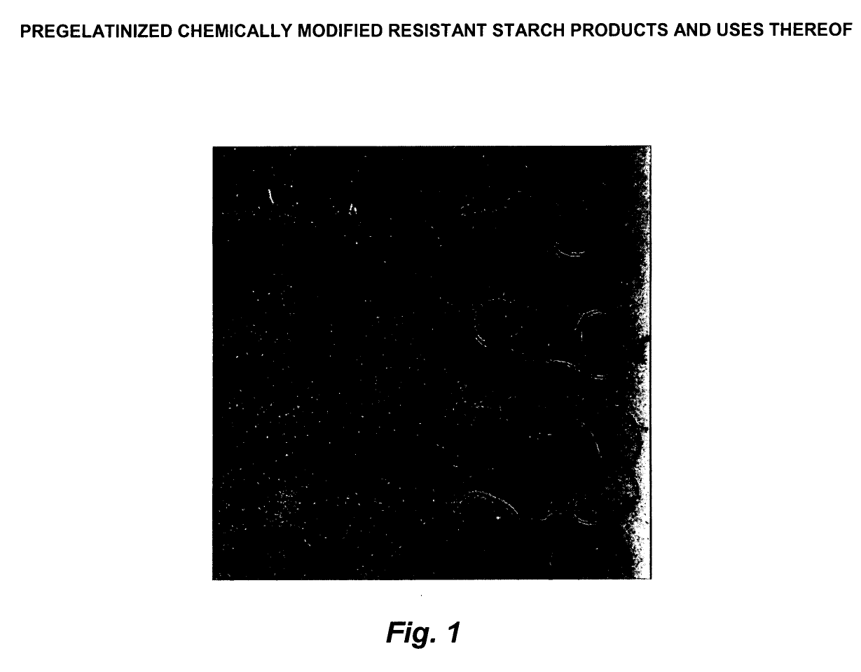

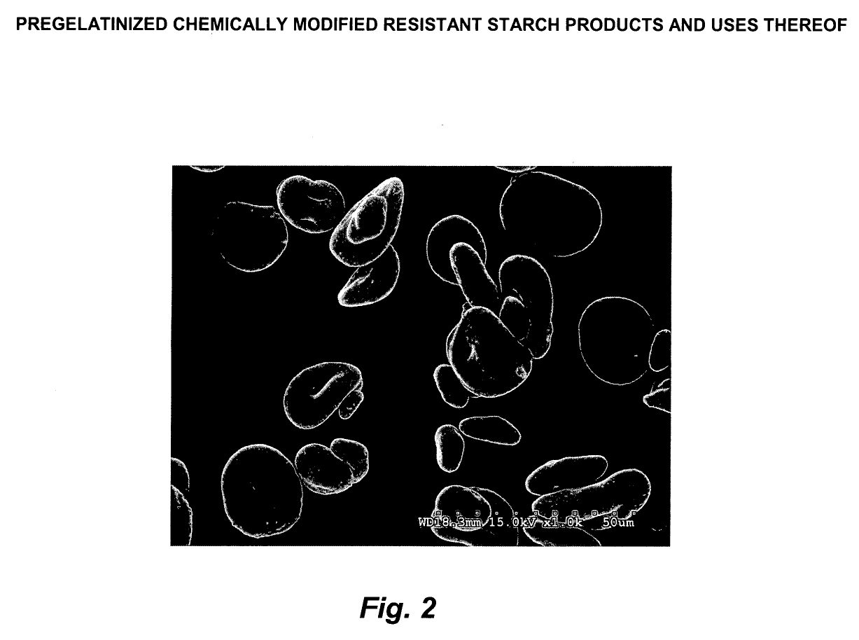

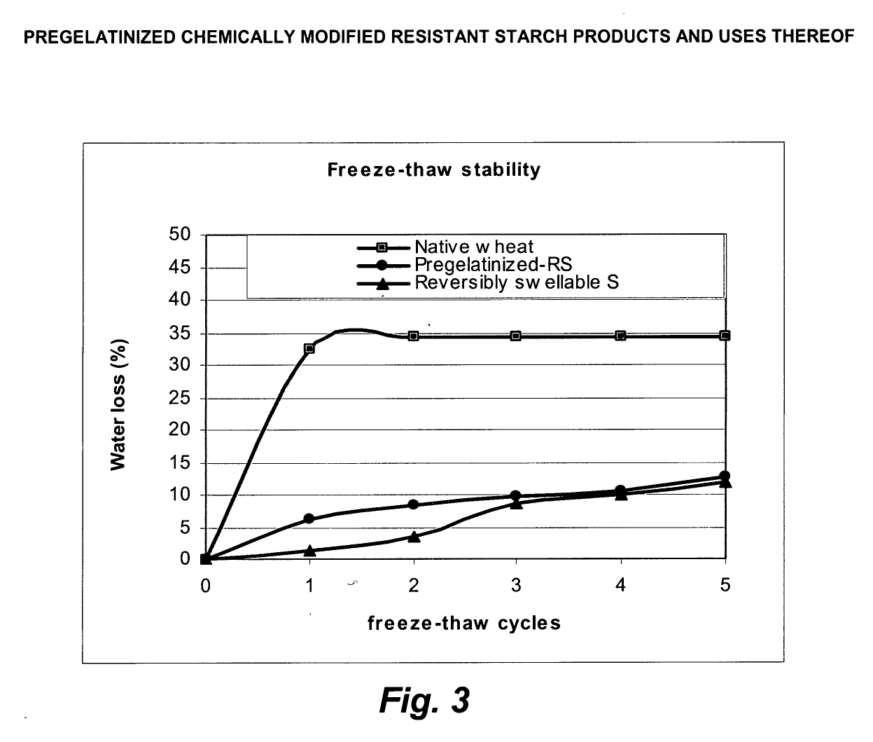

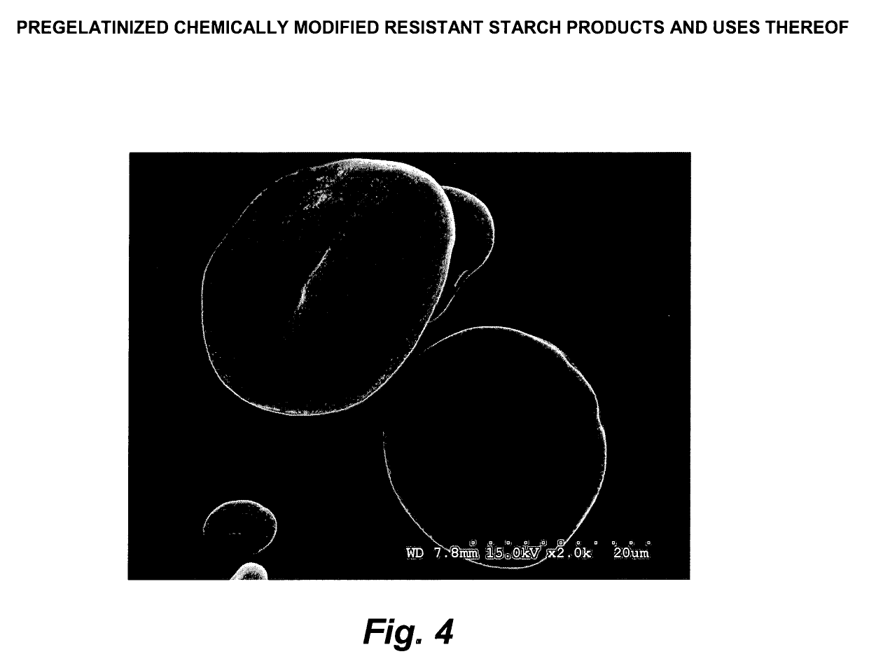

In native or conventional (unmodified) starches, thermal melting of the crystalline phase leads to leaching of amylose fractions, which re-associate to expel water out of the gel system (causing staling) during long term storage. Starch products according to the present instrumentalities show negligible leaching of amylose and do not form a continuous gel. After complete transformation of the crystalline phase to an amorphous phase, the products retain a granular morphology with a smooth surface (FIGS. 1, 2), which advantageously gives a smooth and rich texture in food applications. Restricted re-association of amylose and the intact granular morphology, that is maintained during long term storage, contribute to minimal loss of water during repetitive freezing and thawing cycles (FIGS. 3, 4).

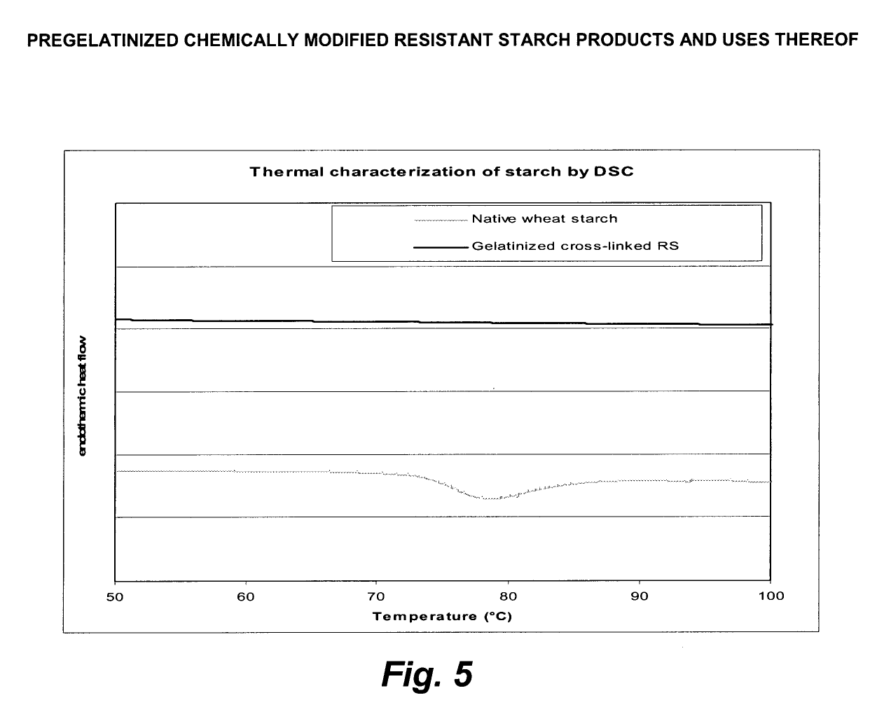

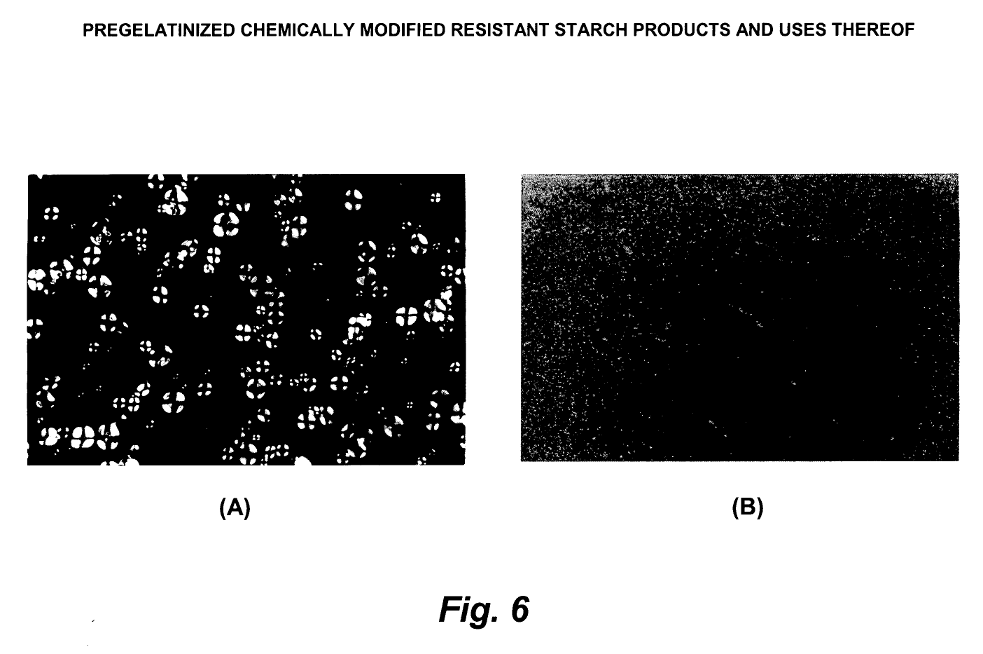

Disappearance of the crystalline phase of the starch products is confirmed by differential scanning calorimetry (DSC) and polarized light microscopy. DSC measures heat flow as a function of temperature. When native granular starch is heated with excess water (starch:water=1:3), melting of the crystalline phase is recorded as a sharp endothermic peak. The area under the curve is the heat energy (enthalpy, ΔH) required to transform the crystalline phase of starch to an amorphous phase. Polarized light microscopy shows the ordered structure of native starch granules as a unique pattern of refraction, called “birefringence” or a “Maltese cross”. It is well known that both the DSC endotherm and the presence of birefringence are correlated with the ordered, crystalline phase of native granular starch. The products described herein show no gelatinization endotherm by DSC (FIG. 5) and no birefringence by polarized light microscopy (FIG. 6B); thus confirming destruction of the native crystalline phase.

The pregelatinized starches disclosed herein may be used in food compositions having high dietary fiber, low fat and/or low calorie content. For example, the pregelatinized starches may be incorporated into food products including, but not limited to, pasta, noodles, cheese, ice creams, yogurts, brownies, cakes and the like. Incorporation of pregelatinized starches into food products fulfills dietary fiber requirements of the finished products. The pregelatinized starches may be incorporated at levels between about 0.1-50% by weight of the total composition. Moreover, the pregelatinized resistant starches may be used to replace 0.1-90% of fats, oils, and/or other calorie dense ingredients, thereby forming a reduced calorie food.

The following examples set forth particular pregelatinized chemically modified resistant starch products in accordance with the instrumentalities reported herein, as well as methods of preparing such products. It is to be understood that these examples are provided by way of illustration only, and nothing therein should be taken as a limitation on the scope of what has been invented, which is defined by the claims that follow.

### EXAMPLES

Materials and Methods

The following describes the materials and general methods used in the Examples; all literature references, including test methods, are incorporated by reference herein.

Materials

The following items were purchased from Sigma Chemical Co. (St. Louis, Mo.); sodium trimetaphosphate (STMP), sodium tripolyphosphate (STPP), 2-(N-morpholino)ethanesulfonic acid (MES, Cat. No. M 8250), tris(hydroxymethyl)aminomethane (TRIS, Cat. No. T 1503), and total dietary fiber assay kit (TDF-100 A). The dietary fiber kit included heat stable α-amylase, with 47,000 U/ml, where 1 unit will liberate 1.0 mg of maltose from starch in 3 min at pH 6.9 and 20° C., amyloglucosidase, with 3690 U/ml, where 1 unit will liberate 1.0 mg of glucose from starch in 3 min at pH 4.5 and 20° C., and protease with 7-15 U/g, where 1 unit will produce a A₂₈₀ of 0.5 in 30 min at pH 7.5 and 30° C. measured as TCA soluble products using N,N-dimethylated casein as substrate. Wheat starch (Midsol 50) and hydroxypropylated (˜4.5%) wheat starch (Midsol 40) were from MGP Ingredients, Inc. (Atchison, Kans.); tapioca starch was from Cargill Inc (Hammond, Ind.); and potato starch was from Penford Food Ingredients (Englewood, Colo.). Phosphoryl chloride was from Aldrich Chemical Company (Milwaukee, Wis.).

Resistant Wheat Starch

Resistant wheat starch was prepared according to the methods described in U.S. Pat. No. 5,855,946.

Wheat starch (50 g, dry basis), water (70 ml), and sodium trimetaphosphate (5.94 g, 11.88%, starch basis, sb), with or without STPP (0.06 g, 0.12%, sb) and sodium sulfate (5 g, 10%, sb) were placed in a round bottom flask, and the mixture was adjusted to pH 11.5 by adding 1.0 M sodium hydroxide (˜25 ml). The slurry was stirred continuously, warmed, and held at 45° C. for 3 h. After that time, the pH of the slurry was found to decline by ˜0.2-0.3 pH units. The slurry was adjusted to pH 6.5 by adding 1.0 M hydrochloric acid, usually less than ˜20 ml, and the starch was collected by centrifugation and washed with water (4×100 ml) and dried at 40° C. The yield of resistant starch was greater than ˜99%.

Resistant Potato Starch

Resistant potato starch was prepared as described above by substituting potato starch for wheat starch.

Resistant Tapioca Starch

Resistant tapioca starch may be prepared as described above by substituting tapioca starch for wheat starch.

Oxidized Resistant Wheat Starch

Resistant wheat starch (60 g) was dispersed in 200 ml water and mixed for 30 minutes. The dispersion was warmed to 45° C. and pH was adjusted to 11.0 with 1 M sodium hydroxide. Sodium hypochlorite 7.5% (dry starch basis) was added to the slurry which was continuously stirred for 16 hours at 45° C. The dispersion was adjusted to pH 6.0 with 1.0 N hydrochloric acid and then cooled to room temperature (25° C.). The ungelatinized starch was washed with water to remove inorganic salts.

General Methods

Total Dietary Fiber Measurement

All chemical analyses were done in triplicate. Total dietary fiber in a pregelatinized form of cross-linked resistant starch was determined using the Sigma TDF-100A kit for AOAC Official Method 991.43 (1995). Starch (1.00 g, dry basis) was dispersed in 0.05M MES-TRIS buffer solution (40 ml, pH 8.2) in a 400 ml tall-form beaker and a heat-stable α-amylase solution (50 μL) was added. The mixture was incubated in a shaking waterbath (Precision, model 25, Winchester, Va.) at 95° C. for 35 minutes. After cooling to 60° C., the mixture was mixed with protease (100 μL) and incubated for 30 minutes. The digest was adjusted to pH 4.5 with 0.561 N hydrochloric acid. Glucoamylase (100 μL) was added and the mixture was incubated for 30 minutes at 60° C. An insoluble residue was precipitated by adding 4 volumes of 95% ethanol. The residue was collected on a diatomaceous earth packed filter, dried overnight at 105° C., weighed and calculated as total dietary fiber.

Differential Scanning Calorimetry

Starch thermal properties were determined by differential scanning calorimetry (DSC) using a Perkin-Elmer Pyres 6, which had been calibrated for temperature and enthalpy measurements using indium and zinc standards. Starch was mixed with water in about a 1:3 ratio (15 mg:45 μL) and sealed in a stainless steel pan. Scanning was performed between 5 and 180° C. at a rate of 10° C./min, and cooling was observed between 180 and 5° C. at a rate of 25° C./min.

Freeze Thaw Stability

Freeze-thaw stability of the pregelatinized chemically modified resistant starch was evaluated by the amount of water released when the starch underwent repeated freezing (−25° C.) and thawing (25° C.) cycles.

Starch (10 g, dry basis) and water (200 ml) were mixed in a 250 ml centrifuge tube. The tube was heated for 30 minutes in a boiling water bath. The starch and water mixture in the tube were mixed by inversion of the tube every minute for the first five minutes of heating. The mixing was then repeated in five-minute intervals for the remaining time. The tube was cooled to room temperature and centrifuged at 3,000*g for 10 minutes. After decantation of the supernatant, the mass of the whole tube was measured. The mixture of starch and water in the tube was frozen at −25° C. overnight and then fully thawed to room temperature. After centrifugation, released water was carefully decanted and measured. The remaining starch/water fraction was subjected to repeated freezing and thawing cycles. The loss of water after each freezing and thawing cycle was measured and divided by the initial weight of starch and water, as determined prior to the first freezing.

Hydration Tests

The product was tested by cold water and hot water hydration tests. In the cold water hydration test, 5 g of starch was dispersed in 100 ml of cold water in a 250 ml beaker for 30 minutes with continuous stirring. The starch/water mixture was then transferred to a graduated cylinder and the swollen volume was measured after 24 hours. A swollen volume (SP25) was determined by measuring the swollen volume of the starch in the graduated cylinder divided by the dry weight of the starch.

In the hot water hydration test, 5 g of starch was dispersed in 100 ml of cold water, and the mixture was heated at 95° C. for 30 minutes with continuous stirring. Thereafter, the mixture was transferred to a graduated cylinder for measurement after 24 hours. As in the cold water hydration test, swollen volume (SP95) was determined by measuring the swollen volume of the starch in the graduated cylinder divided by the dry weight of starch.

### Example 1

Resistant wheat starch (4 kg) was dispersed in 16 L of water, heated to 85° C. and maintained for 1 minute. The pregelatinized starch was collected by spray drying and evaluated as follows:

| | | Pregelatinized |
|---|---|---|
| | RS Wheat | RS Wheat #1 |
| Total Dietary Fiber (dry basis) | 86.5% | 78.2% |
| Particle size (volume average)* | 19.0 μm | 22.0 μm |
| Cold water swelling | 1.6 ml/g | 3.2 ml/g |
| Hot water swelling | 3.4 ml/g | 3.0 ml/g |

*Measured by Coulter counter (Coulter Multicizer II, Beckman Coulter, Inc.)

### Example 2

Resistant potato starch (4 kg) was dispersed in 16 L of water, heated to 85° C. and maintained for 1 minute. The pregelatinized starch was collected by spray drying.

| | | Pregelatinized |
|---|---|---|
| | RS Potato | RS Potato |
| Total Dietary Fiber (dry basis) | 83.4% | 19.5% |
| Particle size (mean volume)* | 34.9 μm | 42.9 μm |
| Cold water swelling | 2.0 ml/g | 4.3 ml/g |
| Hot water swelling | 4.0 ml/g | 4.3 ml/g |

*Measured by Coulter counter (Coulter Multicizer II, Beckman Coulter, Inc.)

### Example 3

Resistant tapioca starch was dispersed in 200 ml of water, heated to 85° C. and maintained for 1 minute. The pregelatinized starch was collected and oven dried.

| | | Pregelatinized |
|---|---|---|
| | RS-Tapioca | RS-Tapioca |
| Total Dietary Fiber (dry basis) | 87.2% | 65.9% |
| Particle size (mean volume)* | 15.5 μm | 14.1 μm |
| Cold water swelling | 2.2 ml/g | 4.0 ml/g |
| Hot water swelling | 3.8 ml/g | 3.7 ml/g |

*Measured by Coulter counter (Coulter Multicizer II, Beckman Coulter, Inc.)

### Example 4

The ungelatinized oxidized starch was dispersed in a large quantity of water, heated to 85° C. and maintained for 1 minute. The pregelatinized starch products were collected by oven drying.

| | RS-Wheat | | Pregelatinized | |
|---|---|---|---|---|
| | Oxidized | | RS-Wheat Oxidized | |
| Total Dietary Fiber (dry basis) | 86.5% | | 83.6% | |
| Particle size (mean volume)* | 19.0 | μm | 20.2 | μm |
| Cold water swelling | 1.6 | ml/g | 3.5 | ml/g |
| Hot water swelling | 3.4 | ml/g | 3.5 | ml/g |
| Lightness (L*) | 100.4 | | 112.1 | |

Lightness (L*) of starches was measured with a CR-410 Minolta chromameter (Ramsey, NJ, USA) calibrated by the manufacture's standard tile with Y = 93.7, x = 0.3163 and y = 0.3329.
*Measured by Coulter counter (Coulter Multicizer II, Beckman Coulter, Inc.)

### Example 5

### Reduced Fat Brownie

Reduced fat brownie was prepared as follows:

1. Dry blend all ingredients.
2. While mixing, add eggs, water and oil at speed one
3. Blend for 1 minute with Hobart mixer, Model 200 (Troy, Ohio) at speed 2 and scrape bowl
4. Blend for 1 min at speed 2
5. Deposit 600 g of batter into 9×9 metal pan

6. Bake at 365° F. for 24-26 minutes

Formulation (by weight)

| | |
|---|---|
| Pastry flour | 11.67% |
| Bread flour | 8.39% |
| Powdered sugar | 32.82% |
| Cocoa powder | 8.75% |
| Salt | 0.70% |
| Corn syrup solids | 2.19% |
| Baking soda | 0.07% |
| Sodium acid pyrophosphate | 0.15% |
| (Rhodia, Cranbury, NJ), SAPP 28 | |
| Potato flour | 1.17% |
| Whole egg | 12.66% |
| Water | 3.12% |
| Canola oil | 13.80% |
| Pregelatinized resistant starch | 4.51% |
| Total | 100% |

### Example 6

### Reduced Fat Peanut Butter Cookie

Reduced fat peanut butter cookie was prepared as follows:

1. Place cream shortening, peanut butter, sugar and Pregelatinized Resistant Wheat Starch in Hobart mixer, model 200 (Troy, Ohio) and mix at speed 2 for 2 minutes and scrape bowl immediately
2. Add egg and vanilla, mix 1 minute at speed 3, and scrape bowl immediately
3. Add flour, soda, and salt, mix at speed 3 for 1 minute, and scrape bowl immediately

4. Bake at 365° F. in a convection oven at fan speed 4 for 8 minutes.

Formulation (by weight)

| | |
|---|---|
| Pastry flour | 11.67% |
| Bread flour | 8.39% |
| Powdered sugar | 32.82% |
| Cocoa powder | 8.75% |
| Salt | 0.70% |
| Corn syrup solids | 2.19% |
| Baking soda | 0.07% |
| Sodium acid pyrophosphate | 0.15% |
| (Rhodia, Cranbury, NJ), SAPP 28 | |
| Potato flour | 1.17% |
| Whole egg | 12.66% |
| Water | 3.12% |
| Canola oil | 13.80% |
| Pregelatinized resistant starch | 4.51% |
| Total | 100% |

### Example 7

### Reduced Fat Sugar Cookie

Reduced fat sugar cookie was prepared as follows:

1. Cream shortening and sugar together, in Hobart mixer, model 200 (Troy, Ohio) and mix at speed 2 for 2 minutes.
2. Dry blend all dry ingredients
3. Add water
4. Blend for 1 minute at speed 2 and scrape bowl
5. Blend for 1 minute at speed 2
6. Roll dough out and cut with 77 mm cookie cutter

7. Bake at 355° F., fan speed 4 for 12 minutes.

Formulation (by weight)

| | |
|---|---|
| Pastry flour | 42.41% |
| Sugar | 21.20% |
| Shortening | 12.91% |
| Non-fat dry milk | 2.12% |
| Salt | 0.42% |
| Baking powder | 0.42% |
| Baking soda | 0.34% |
| Water | 14.00% |
| Pregelatinized resistant starch | 6.17% |
| Total | 100% |

### Example 8

### Reduced Fat Cinnamon Roll

Reduced fat cinnamon roll was prepared as follows:

1. Add all ingredients to mixing bowl
2. Mix 2 minutes at low speed
3. Mix 12-18 minutes at high speed
4. Desired dough temperature is 76-78° F.
5. Allow 10 minutes floor time
6. Roll dough to ¼ inch thickness
7. Apply fiber enriched cinnamon roll filling to desired amount
8. Proof 106° F./102° F. for 30-60 minutes

9. Bake 375° F. for 20 minutes

Formulation (by weight)

| | |
|---|---|
| Bread flour | 52.95% |
| Water | 26.21% |
| Sugar | 7.94% |
| Shortening | 0% |
| Salt | 0.98% |
| Non fat dry milk | 0.79% |
| Eggs | 4.24% |
| Double acting baking powder | 0.26% |
| L-Cysteine | 0.0025% |
| Yeast | 3.71% |
| Color | 0.01% |
| Azodicarbonamide | 0.001% |
| Sodium stearoyl lactylate | 0.26% |
| Pregelatinized resistant starch | 2.65% |
| Total | 100% |

### Example 9

### Fiber Enriched Cinnamon Roll Filling

Fiber enriched cinnamon roll filling was prepared as follows:

1. Add all ingredients together and dry blend thoroughly
2. Measure water (32° C.) at 75% of cinnamon roll filling mix
3. Add half of the water to filling mix
4. Mix to thoroughly eliminate lumps
5. Add remaining water and mix until water is thoroughly blended

6. Allow filling to hydrate for 30 minutes before use

Formulation (by weight)

| | |
|---|---|
| Powdered sugar | 46.73% |
| CMC gum | 0.93% |
| Pregel 46* | 4.67% |
| Cinnamon | 9.35% |
| Salt | 0.93% |
| Wheat fiber | 4.67% |
| Sugar | 18.69% |
| Pregelatinized resistant starch | 14.02% |
| Total | 100% |

*Pregel 46 = Modified food starch supplied by MGP Ingredients, Inc.

### Example 10

### Reduced Fat Buttermilk Biscuit

Reduced fat buttermilk buscuit was prepared as follows:

1. Blend all dry ingredients
2. Add shortening and ingredients
3. Mix 1-3 minutes
4. Roll to approximately ¾ inch thickness
5. Cut biscuits to desired size

6. Bake at 400° F. for 19-23 minutes

Formulation (by weight)

| | |
|---|---|
| Party flour | 33.51% |
| Patent flour | 14.37% |
| Sugar | 1.92% |
| Palm shortening flakes | 7.19% |
| Salt | 0.98% |
| Sodium caseinate | 0.12% |
| Double acting baking powder | 2.87% |
| Pregelatinized resistant starch | 2.16% |
| Liquid buttermilk | 19.16% |
| Water | 17.72% |
| Total | 100% |

### Example 11

### Reduced Fat Blueberry Muffin

Reduced fat blueberry muffin was prepared as follows:

1. Dry blend all ingredients
2. Add eggs and mix for 1 minute at speed 1 with Hobart mixer Model 120 (Troy, Ohio)
3. Mix for 2 minutes at speed 2
4. Add water and oil and mix at speed 1 for 1 minute and scrap bowl
5. Mix for 1 minute at speed 1
6. Fold blueberries into batter carefully till evenly blended
7. Scale 63-65 grams in lined or greased muffin cups

8. Bake at 375° F. for 22-24 minutes

Formulation (by weight)

| | |
|---|---|
| Sucrose | 21.91% |
| Cake flour | 15.24% |
| Bread flour | 3.81% |
| Cake shortening | 3.24% |
| Vital wheat gluten | 0.19% |
| Nonfat dry milk | 1.91% |
| Salt | 0.36% |
| Baking soda | 0.31% |
| Sodium aluminum phosphate | 0.29% |
| Monocalcium phosphate monohydrate | 0.04% |
| Baking powder | 0.15% |
| Pregel 40* | 1.14% |
| Butter and vanilla flavor | 0.23% |
| Xanthan gum | 0.10% |
| Sodium stearyl lactylate | 0.10% |
| Whole egg | 14.71% |
| Water | 16.76% |
| Soy oil | 3.28% |
| Pregelatinized resistant starch | 2.50% |
| Blueberries | 13.73% |
| Total | 100% |

*Pregel 40 = Modified food starch supplied by MGP Ingredients, Inc.

### Example 12

### Reduced Fat White Cake

Reduced fat white cake was prepared as follows:

1. Dry blend all ingredients
2. While mixing, add 11.83% of water at speed 1 for 1 minute using Hobart mixer Model 120 (Troy Ohio)
3. Mix for 3 minutes at speed 2 using Hobart mixer model 120
4. While mixing, add 8.85% of water at speed 1 and scrap bowl
5. Mix for 2 minutes at speed 2
6. Add 8.85% water and mix for 2 minutes at speed 1
7. Scale 400 g of batter into 8 inch round pan

8. Bake for 24-26 minutes at 350-355° F.

Formulation (by weight)

| | |
|---|---|
| Sucrose | 28.50% |
| Cake flour | 16.40% |
| Cake shortening | 9.50% |
| Pregelatinized resistant starch | 7.25% |
| Vital wheat gluten | 0.75% |
| Dry egg whites | 1.25% |
| Dry whole eggs | 2.10% |
| Whey protein isolate | 0.50% |
| Non-fat dry milk | 1.52% |
| Salt | 0.70% |
| Baking soda | 0.40% |
| Sodium aluminum phosphate | 0.45% |
| Monocalcium phosphate monohydrate | 0.05% |
| Pregel 40* | 0.50% |
| Sodium stearyl lactylate | 0.25% |
| Flavor | 0.30% |
| Carboxymethyl cellulose | 0.05% |
| Water | 29.53% |
| Total | 100% |

*Pregel 40 = Modified food starch supplied by MGP Ingredients, Inc.

### Example 13

### High Fiber, Instant Mashed Potatoes

High fiber, instant mashed potatoes were prepared as follows:

Formulation (by weight)

| Dry ingredients | |
|---|---|
| Instant mashed potatoes | 67.21% |
| Fibersym 80 ST* | 22.40% |
| Pregelatinized resistant starch | 10.18% |
| Total | 100%% |
| Wet ingredients | |
| 2% milk fat | 33.57% |
| Water | 60.30% |
| Table salt | 0.42% |
| Margarine or butter | 5.81% |
| Total | 100% |

*Fibersym 80ST = Modified food starch supplied by MGP Ingredients, Inc.

Cooking instructions: Stove top
1) Heat water, milk, margarine and salt to boiling in a saucepan (200-205° F.).
2) Remove from heat. Stir in potato flakes using a fork until blended. Let stand until liquid is absorbed.
3) Whip with fork.
   Cooking instructions: Microwave
1) Combine water, milk, margarine, salt and mashed potato packet until moistened in a microwave safe bowl.
2) Cover with plastic wrap and microwave on high for 2-4 minutes, until hot.
3) Remove carefully from microwave. Whip with fork until potatoes are desired consistency.

### Example 14

### Reduced Fat Meat Products

Reduced fat meat products, including dry sausages, semi-dry sausages, emulsified sausages and high fat sausages, were prepared as follows:

1. Grind, chop, or mince meat
2. Mix with seasoning and salt
3. Add fat replacer substance
4. Mix cure and/or encapsulated acid, starter culture bacteria
5. Stuff into casing (range of sizes from 5 mm to 200 mm)

6. Follow cure, cook, or drying procedures outlined in the Code of Federal Regulations, Title 9, Part 200 to End.

Formulation (by weight)

| | |
|---|---|
| Any combination of pork, beef, and chicken | 25-95% |
| Salt | 0.5-2.0% |
| Seasoning | 0.5-6.0% |
| Curing compounds | 0.01-0.25% |
| Water | 0-40% |
| Encapsulated acids | 0.1-3.5% |
| Starter culture | 0.01-5.0% |
| Pregelatinized resistant starch | 0.01-15% |

### Example 15

### Reduced Fat Cheesecake

Reduced fat cheesecake was prepared as follows:

1. Whip Neufchatel cheese in a Hobart mixer (Speed #1, 2 minutes) at 22° C.
2. Blend all dry ingredients: sugar, pregelatinized resistant wheat starch, Midsol 46* and whey protein concentrate. Add to the cheese mix and mix thoroughly at speed 1.
3. Add eggs, light sour cream and water and mix at speed 2 until a homogenous mass is achieved.
4. On an 8″ round pie crust pan, pour 500 g of the above mass. Place the pan in the container with 1″ of hot water.

5. Bake at 177° C. for 10 minutes, and then bring the temperature down to 150° C. Bake for 70-75 minutes. Refrigerate overnight before serving.

Formulation (by weight)

| | |
|---|---|
| Neufchatel cheese | 43.60 |
| Sucrose | 21.60 |
| Eggs | 13.20 |
| Light sour cream | 6.60 |
| Pregelatinized resistant starch | 6.60 |
| Water | 6.34 |
| Midsol 46* | 1.00 |
| Whey protein concentrate (80%) | 1.00 |
| Cream cheese flavor | 0.06 |
| Total | 100 |

*Midsol46 = Modified food starch supplied by MGP Ingredients, Inc.

### Example 16

### Dietary Fiber Enriched Salad Dressing

Dietary fiber enriched and calorie reduced salad dressing was prepared as follows:

Pregelatinized resistant wheat starch was used to replace 50% of the vegetable oil in salad dressing. The salad dressing provides a significant level of dietary fiber (7% of daily value based on 2,000 calorie diet, when consumed per serving of 32 g) and has ⅓ fewer calories.
1. Mix all ingredients (base paste) together and put in a steam cooker
2. Cook base paste to 190-200° F.
3. Cool base paste to room temperature overnight
4. Measure base paste (60.5%) in a food processor
5. Mix water and pregelatinized resistant starch and let sit 5 minutes
6. On low speed add egg yolk (4.0%), and then chilled oil (17.5%)
7. Add the starch paste (17.5%) of step 5
8. Mix on “high” speed and liquefy for 1.5 minutes

9. Fill jars and refrigerate

Formulation (by weight)

| | % |
|---|---|
| Base paste | |
| Water | 51.48 |
| Corn syrup | 16.20 |
| White distilled vinegar | 12.56 |
| Sugar | 9.60 |
| Midsol 4 (60%) + Midsol1020 (40%)* | 6.41 |
| Salt | 2.00 |
| Mustard flour | 1.00 |
| Lemon juice | 0.50 |
| Sodium benzoate | 0.25 |
| Starch paste | |
| Water | 51.42 |
| Pregelatinized resistant starch | 100.00 |

*Midsol 4 and Midsol 1020 = Modified food starch supplied by MGP Ingredients, Inc.

### Example 17

### Reduced Fat Ice Cream

Fat (25%) reduced and dietary fiber enriched ice cream was prepared by the following procedure:

1. Blend dry ingredients
2. Add dry ingredients to lukewarm milk (110° F.) while constantly agitating
3. Heat to 140° F. and homogenize at 2000 psi (1^{st} stage) and 500 psi (2^{nd} stage)
4. Pasteurize up to 180° F. for 25 seconds
5. Cool to 40° F., add color and flavor and mix well
6. Freeze until draw temperature reaches 21° F. and ˜100% overrun
7. Package at 21° F.
8. Transfer for hardening at −45° F. to −50° F. up to 24 hours

9. Store at −10° F. to −20° F.

Formulation (by weight)

| | |
|---|---|
| Whole milk (3.3%) | 62.29 |
| Heavy cream (40%) | 13.04 |
| Sugar | 9.90 |
| Corn syrup solid (DE 42) | 2.99 |
| Non Fat Dry Milk | 6.55 |
| Pregelatinized resistant starch | 4.98 |
| Stabilizer and emulsifier blend | 0.25 |
| Total | 100% |

Vanilla (2×) 7 ml/1000 g mix and Annatto color as desired.

### Example 18

### Low Fat Sundae Style Yogurt

Sundae style yogurt was prepared by the following procedure:

1. Blend dry ingredients
2. Reconstitution in milk (110° F.)
3. Double homogenize (2000/500 psi)
4. Pasteurize (200° F., 5 minutes)
5. Cool to 107° F.
6. Culture inoculation (at 0.98%)
7. Fill cups with fruit (15%) and inoculated milk (85%)
8. Incubation (107° F.)
9. Break acidity (0.9% lactic acid)

10. Store at 40-45° F.

Formulation (by weight)

| | |
|---|---|
| Milk (3.3%) | 83.47% |
| Sugar | 7.64% |
| Non fat dry milk | 3.25% |
| Pregelatinized resistant starch | 3.20% |
| Midsol 46* | 1.45% |
| Culture | 0.99% |
| Total | 100% |

Strawberry puree is added 15.0% based on total weight 100% of the above ingredients.
*Midsol46 = Modified food starch supplied by MGP Ingredients, Inc.

### Example 19

Reduced Fat Crème Filling

Reduced fat crème filling was proposed as follows:

1. Mix all ingredients and water (part 1) for one minute at speed 1. Then mix five minutes at speed 2.
2. Scrape bowl.
3. Add water (part 2) slowly while mixing at speed 1 for one minute. Then mix five minutes at speed 2.
4. Scrape bowl.
5. Add water (part 3) slowly while mixing at speed 1 for one minute. Then mix five minutes at speed 2.
6. Scrape bowl.

7. Mix 10 minutes at speed 1.

Formulation (by weight)

| | |
|---|---|
| Powdered Sugar | 44.17% |
| Cake and Icing Shortening | 11.92% |
| Pregelatinized Resistant Starch | 14.58% |
| Salt | 0.22% |
| Non Fat Dry Milk | 4.42% |
| Polysorbate 60 | 0.17% |
| Vanilla Extract | 0.22% |
| Water (part 1) | 8.10% |
| Water (part 2) | 8.10% |
| Water (part 3) | 8.10% |
| Total | 100% |

Changes may be made in the above compositions and methods without departing from the invention described in the Summary and defined by the following claims. It should thus be noted that the matter contained in the above description or shown in the accompanying drawings should be interpreted as illustrative and not limiting.

All references cited are incorporated by reference herein.

We claim:

1. A pregelatinized starch comprising a plurality of individual, cross-linked starch granules, said granules lacking a crystalline phase.

2. The starch of claim 1, wherein said starch granules are derived from the group of starch sources consisting of cereal, root, tuber and legume.

3. The starch of claim 2, wherein said starch granules are derived from the group of starch sources consisting of wheat, waxy wheat, corn, waxy corn, high amylose corn, oat, rice, tapioca, mung bean, sago, sweet potato, potato, barley, triticale, sorghum and banana.

4. The starch of claim 2, wherein said granules are cross-linked by a cross-linking agent selected from the group consisting of phosphorylating agents, adipic acid, epichlorohydrin and mixtures thereof.

5. The starch of claim 4, wherein said phosphorylating agent is selected from the group consisting of sodium trimetaphosphate, sodium tripolyphosphate, phosphoryl chloride and mixtures thereof.

6. The starch of claim 1, wherein said starch granules are oxidized.

7. The starch of claim 1, wherein the starch is stable during successive freezing and thawing cycles without the loss of more than about 25% water content.

8. The starch of claim 1, wherein the starch is stable during successive freezing and thawing cycles without the loss of more than about 20% water content.

9. The starch of claim 1, wherein said starch contains at least about 0.1% by weight phosphorus.

10. The starch of claim 1, wherein said starch absorbs at least about 2.5 ml/g cold water.

11. The starch of claim 1, wherein said starch absorbs at least about 3.0 ml/g cold water.

12. The starch of claim 1, wherein a differential scanning calorimetry graph of the pregelatinized starch does not show an endothermic gelatinization transition.

13. The starch of claim 1, wherein a lack of birefringence is observed when the pregelatinized starch is viewed in plane polarized light under a microscope.

14. A food product including therein the starch of claim 1.

15. The food product of claim 14, wherein the food product is selected from the group consisting of cereal grain, frozen desserts, yogurt, ice cream, reduced fat brownie, reduced fat peanut butter cookie, reduced fat sugar cookie, reduced fat cinnamon roll, fiber enriched cinnamon roll filling, reduced fat buttermilk biscuit, reduced fat blueberry muffin, reduced fat white cake, high fiber, instant mashed potatoes, reduced fat meat products, reduced fat cheesecake, dietary fiber enriched salad dressing, reduced fat ice cream, sundae style yogurt, and reduced fat crème filling.

16. A food product including therein the starch of claim 1 in an amount between about 1-50 weight % based on the weight of the uncooked food product.

17. A food product including therein the starch of claim 1 in an amount between about 2-10 weight % based on the weight of the uncooked food product.

18. A cross-linked and pregelatinized granular starch exhibiting at least about 20% resistance to α-amylase digestion using AOAC method 991.43.

19. A method of preparing a pregelatinized starch comprising:
forming a dispersion of starch granules in water, said granules having a crystalline phase;
adding a cross-linking agent to said dispersion while said granules are swelled; and
heating said cross-linked starch dispersion in order to completely melt the crystalline phase of said granules without disrupting the granular morphology.

20. The method of claim 19, further comprising:
isolating the starch granules, and
mixing the isolated starch granules with a food composition.
